(19) United States
(12) Patent Application Publication
(10) Pub. No.: US 2018/0268462 A1
(43) Pub. Date: Sep. 20, 2018

(54) GROCERY AND DELIVERY SERVICE SYSTEM AND METHOD

(71) Applicants: Jeff Brown, Valdosta, GA (US); Rick Ambrozic, Valdosta, GA (US)

(72) Inventors: Jeff Brown, Valdosta, GA (US); Rick Ambrozic, Valdosta, GA (US)

(21) Appl. No.: 15/922,680

(22) Filed: Mar. 15, 2018

Related U.S. Application Data
(60) Provisional application No. 62/471,943, filed on Mar. 15, 2017.

(51) Int. Cl. G06Q 30/06; G06Q 10/08; G01S 19/13

(52) U.S. Cl. CPC G06Q 30/0635; G06Q 30/0623; G06Q 30/0222; G01S 19/13; G06Q 10/0833

(57) ABSTRACT

A grocery/retail service automates deliveries from local retail establishments. The “SERV” system and method implements the usage of application technology to deploy reps to deliver items requested by customers. SERV enables customers to order groceries or other items from a cellular device or computer, and set delivery times that coincide with their busy schedules. SERV accomplishes this service through GPS location technology, online inventory databases of retail stores, and customer-oriented reps hired to deliver items. Customers will be able to place orders, track delivery of goods, tip reps for service, and view receipt of order via email.

### REFERENCE TO RELATED APPLICATIONS

This application claims the benefit of, and priority to, U.S. Provisional Patent Application Ser. No. 62/471,943, filed Mar. 15, 2018, the entire content of which is incorporated herein by reference.

### FIELD OF THE INVENTION

This invention relates generally to grocery/retail delivery services and, in particular, to a computer application that deploys reps to deliver items requested by customers.

### BACKGROUND OF THE INVENTION

Grocery shopping can be a time-consuming process, and many individuals are not able to grocery shop due to time constraints and/or physical disabilities. Thus, the need remains for a system and method to automate the process of grocery shopping.

### SUMMARY OF THE INVENTION

In broad and general terms, this invention is directed to grocery/retail delivery service from local retail establishments. Referred to herein as “SERV,” the system implements the usage of application technology to deploy reps to deliver items requested by customers. SERV enables customers to order groceries or other items from a cellular device or computer, and set delivery times that coincide with their busy schedules. SERV accomplishes this service through GPS location technology, online inventory databases of retail stores, and customer-oriented reps hired to deliver items. Customers will be able to place orders, track delivery of goods, tip reps for service, and view receipt of order via email.

### BRIEF DESCRIPTION OF THE DRAWINGS

The SERV system incorporates three different applications: user/customer facing application, a driver application, and a management facing application. The accompanying Figures illustrate various screen displays, wherein:

FIG. 1 is a Login/Sign up Screen;

FIG. 2 shows Select Store, Fast Food or Restaurant options;

FIG. 3 illustrates a Select Your Items menu;

FIG. 4 shows a Checkout/Promo Code Entry; and

FIG. 5 depicts an Order Received and Tracking Screen.

### DETAILED DESCRIPTION OF THE INVENTION

The application will be available for IOS and Android devices. After users have downloaded SERV, they will open the application and be prompted to login or sign up for SERV.

### SERV Application Layout

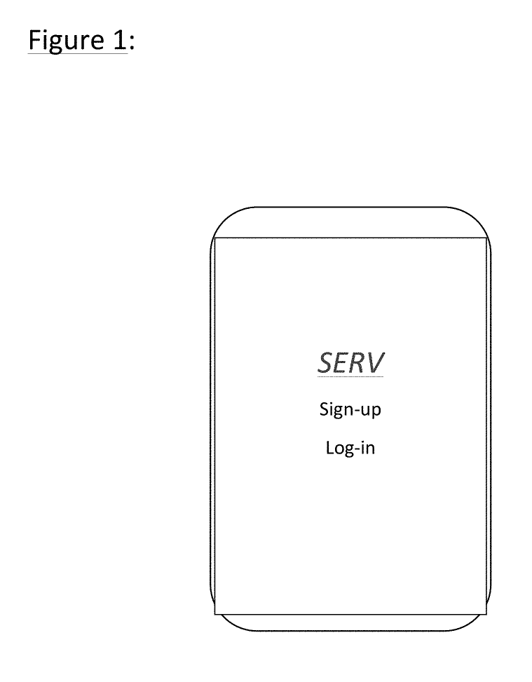

FIG. 1 is a Login/Sign up Screen. New users sign-up for SERV or existing users log-in. User's will input personal information as well as payment information. The following information will be required: first name, last name, address, phone number, email address, and a ‘how did you hear about us’ section. Payment information can also be entered at this time, or once the customers have proceeded to checkout. Once users have entered a payment method, we will initiate a pending charge for a minimal amount to verify that the card is active. The charge will drop-off within the next few days.

After successfully completing the login/sign up, users will be directed to a page that will allow them to select an option for using SERV. The following are base figures we have initially implemented and may be subject to change:

Option 1:
Monthly Subscriber fee of $9.99
Flat Delivery Fee of $5.00
Service Charge of 10% of total goods purchased on the order.

Option 2:
Non Subscriber Option
Delivery fee begins at $5.00 and fluctuates based on distance.
Service Charge of 15%, and subject to surges during peak hours.

Users will also have the option to make their selection now, or adjust it on the Account screen at a later time. Once the users have completed this step, they will be directed to the Home screen of the application. From here, users will be able to view the available stores based on the time and relative location. Users can now browse the inventory of the available stores and begin adding items to their cart that they would like our reps to SERV for them.

Along with the Home screen, the following tabs will be provided: Order Tracker, Account, About Us, FAQ's, and Support. These are also subject to change pending the need for more/less screens throughout application development process.

### SERV Application Usage

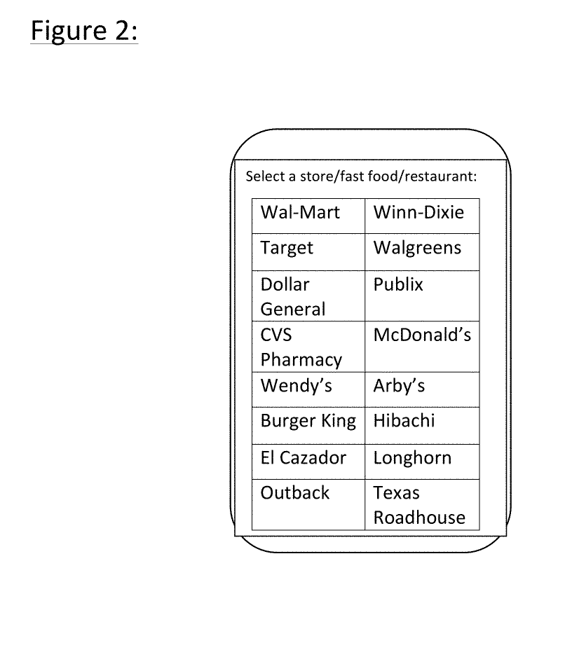

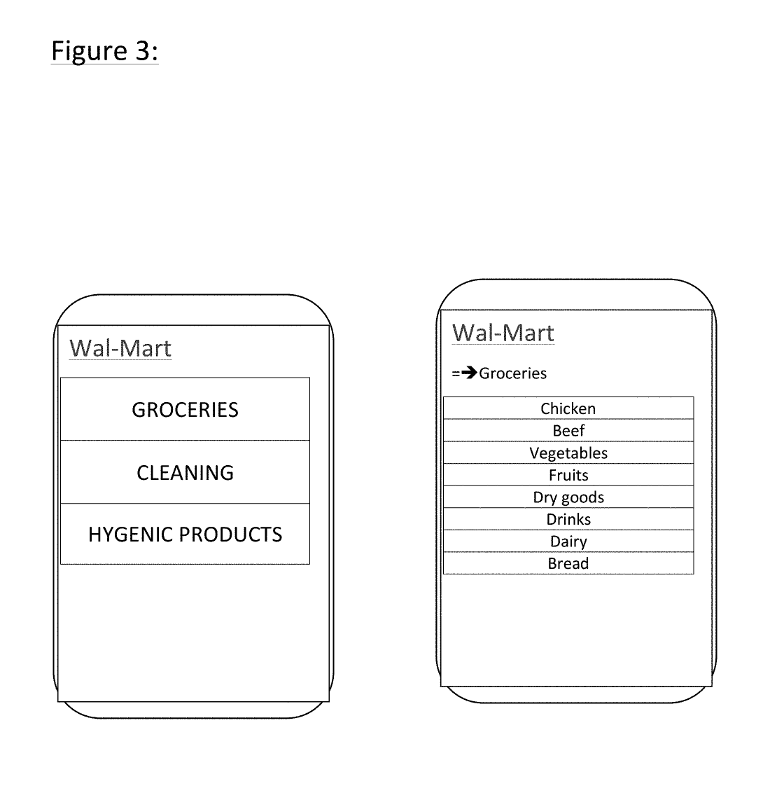

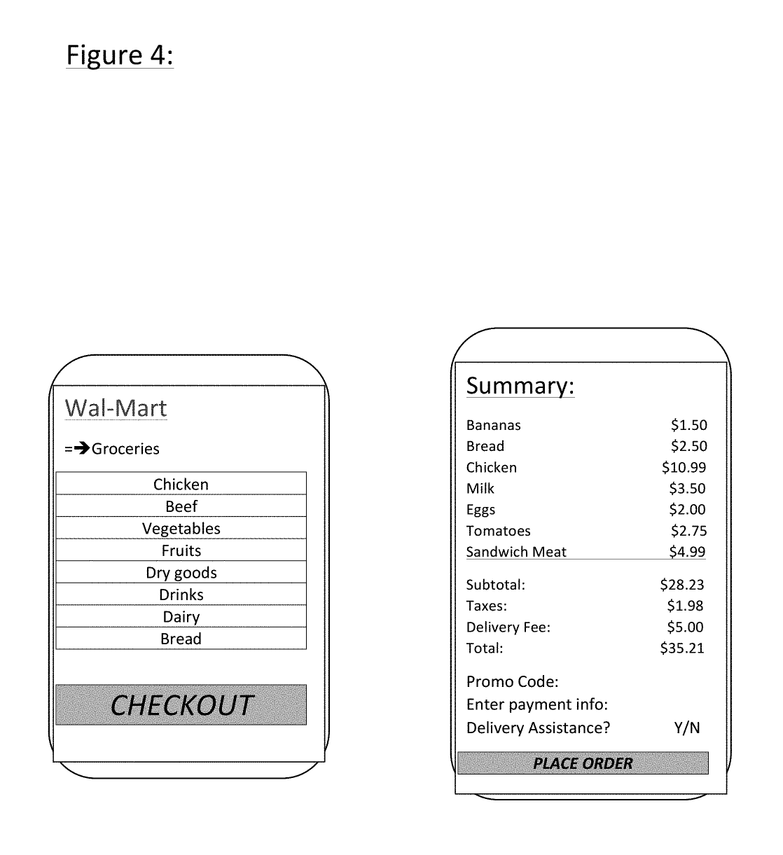

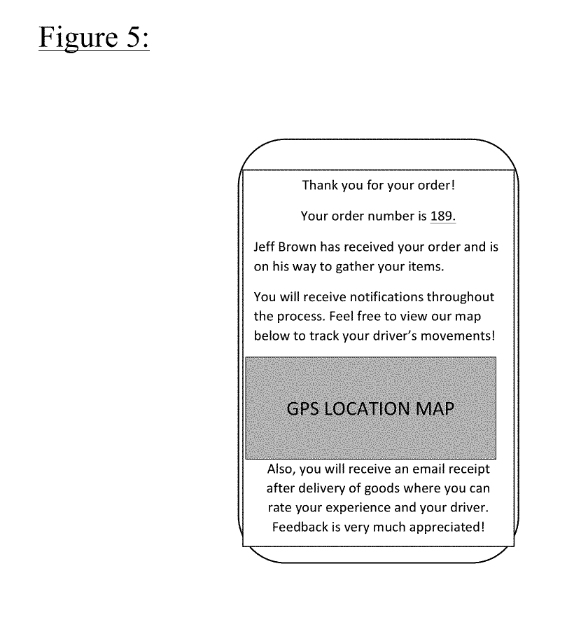

The SERV Application involves a simple set of steps for ease of use. We believe that the simpler this process is, the more effective it will be. After the users have gone through the process of downloading the application and signing up/logging in, they are prepared to use the application. The steps are listed below.
1) Select a store. Users will have an array of stores based on their location. These stores will be listed and easily accessible within the application. FIG. 2 shows Select Store, Fast Food or Restaurant options. These options are based on local region of the user. The example uses stores within Valdosta, Ga. area. Once a user has selected a store/fast food/restaurant option, it will drill down into their inventory/menu.
2) Select items. Once the user has selected a store, they will now be taken to a digital version of the stores available inventory. Here they can select from various items to add to their cart. FIG. 3 illustrates a Select Your Items menu. This screen displays inventory/items at your fingertips. Here the customer can add various items to their cart. In this example below, the user selects Wal-Mart and then selects Groceries. Various items generate according to the store's inventory.
3) Checkout and promo code input. Here users can view their cart, enter any promotional codes they may have, and enter payment information for their order. FIG. 4 shows a Checkout/Promo Code Entry. Here users can view their cart, enter any promotional codes they may have, and enter payment information for their order. Users can also opt in for delivery assistance. The last button the user will click upon completion will be “SERV ME!”.
4) Order received by representative notification. FIG. 5 depicts an Order Received and Tracking Screen. After the items have been selected and the order has been finalized, a driver will receive a notification of the order and opt to process that order. The user will receive a notification such as: “Joe has received your order and is on his way to gather your goods.”
5) Notifications and tracker feature within application. Once an order is in the hands of a driver, the user will receive periodic notification updates (if willing) on the step-by-step process of the order. Examples include: “Joe is gathering your items”, “Joe has checked out and is on his way”, “Joe's estimated arrival time is 7:35 p.m.”, “Joe is halfway to your location”, and “Joe has arrived with your items.” Also, a tracking tab will be included within the application so users can follow the driver's movements live using GPS location technology.
6) Delivery assistance feature. Users will have an option they may select to assist with bringing groceries/goods into the home and assisting with placement/unloading of the products. Some users may not be comfortable with this feature and can select the option to decline.
7) Email receipt and review of driver. A receipt of the user's order will be sent via email and will have a brief summary of the order total and items. There will also be a highlighted section encouraging the user to review the experience with the driver. Incentives such as “free delivery charge on next order”, “free service charge on next order”, or overall reductions in standard rates to incentivize the review process.

### Driver/Rep Compensation

SERV plans to implement a lucrative payout structure for driver and representatives. We have formulated a lucrative structure for employees that drive for SERV. All drivers will be independent contractors within the organization. They will be responsible for reporting their earnings to the IRS through 1099 forms that we will fill out and send to our independent contractors. Also, SERV may employ a number of support team members, either full-time or part-time, to assist with problems that may arise with orders. The payout structure for drivers is listed below and is subject to change.

### Proposed Payout Structure

Driver's earn the Delivery fee associated with each order. SERV will also incorporate a tipping platform within the application.

Users will be able to tip before or after the order has been concluded. Tips will be paid to the driver in the same way a server earns tips. We are working on implementing a payment solution that will assist with tip payouts after a shift has been concluded.

Drivers will also earn more for users that decline to subscribe for monthly option with lower fees. The delivery fee fluctuates based on distance with these users, and drivers will also earn the full amount of the delivery fee from both options. This incentivizes drivers to process orders that possess longer distances between pick-up and drop-off locations.

Delivery fee may initially begin at a set amount such as $5.00 for subscribers, and $5.00 plus adjustments based on distance for non-subscribers.

Checks for delivery fees earned through orders processed may be paid out weekly or bi-weekly.

The Service fee associated with every order is retained by SERV.

A potential bonus bracket may be implemented to encourage drivers to process more orders. Example: After processing X amount of orders, a bonus may be added onto each consecutive order past that mark that SERV establishes. Therefore, after ten orders in a single shift are processed by Driver A, that driver now receives a bonus associated with every order thereafter. This bonus and its variables are will differ depending on region, time, and number of orders.

SERV will also give top independent contractors bonuses based on number of orders processed, user reviews, and deliveries made on time.

### Advantages of the Invention

1. Puts essential time back into the customer's hands. SERV saves you that trip to the grocery store and enables you to do more valuable things with your time. Such conveniences clearly improve the operation of smartphone or other portable/electronic device by performing functions that are not executed by existing devices.
2. A solution for everyone to automate grocery shopping. Whether the car is in the shop, your child has a game after work that you would like to attend, you're physically unable to visit the store, or you dislike shopping for groceries altogether, the system and method disclosed herein accommodates all different users.
3. Creates a delivery method that is non-existent for major retailers, local small businesses, and farmer's markets. SERV will assist these businesses with reaching customers that were previously unattainable. As such, the invention improves technologies and application areas that are outside the realm of shopping.
4. Customers can now achieve savings from stores they previously preferred not to visit. Let's say Store A has substantially lower prices than Store B; however, Store A has fewer registers open, which results in longer wait times at checkout, or also lacks appropriate customer service. This deters the customer from shopping at Store A. Store B is now shopped at although prices are slightly higher—the shopping experience is then more efficient, but also costlier. SERV alleviates this issue. We shop at Store A for you, and pass the savings onto you without the hassle.

1. A system for automating the process of shopping, comprising:
a computer device executing an application software program, the program being operative to perform the following functions:
select a store by a user;
display to the user information regarding the store's available inventory, wherein a user adds one or more items to a virtual shopping cart;
enter promotional codes or payment information by the user;
automatically notifying a driver to delivery the one or more items to the user at a specified address; and
track the delivery of the order to the specified address, thereby enabling the user to follow the driver's movements live using GPS location technology.

2. The system of claim 1, wherein the computer device is a smartphone or other portable electronic device.
